(19) United States
(12) Patent Application Publication
(10) Pub. No.: US 2026/0281067 A1
(43) Pub. Date: Sep. 17, 2026

(54) METHOD AND APPARATUS FOR INSTANT MESSAGE PRESENTATION, AND ELECTRONIC DEVICE AND MEDIUM

(71) Applicant: Beijing Zitiao Network Technology Co., Ltd., Beijing (CN)

(72) Inventors: Hongye QI, Beijing (CN); Huimin WU, Beijing (CN); Eryou HAO, Beijing (CN); Ping YUAN, Beijing (CN); Yanping CHEN, Beijing (CN); Junzhou YANG, Beijing (CN); Yuanhang XIE, Beijing (CN); Sanwei TIAN, Beijing (CN); Zhenghua HAO, Beijing (CN); Cheng CHENG, Beijing (CN); Runqiong WANG, Beijing (CN); Yuwen HUANG, Beijing (CN); Zhongjie FU, Beijing (CN); Yonghui PAN, Beijing (CN); Zihuan LIN, Beijing (CN); Xiaowen LV, Beijing (CN); Qinggui XIE, Beijing (CN); Weiquan WU, Beijing (CN); Yaojia GUO, Beijing (CN); Zhiwu HU, Beijing (CN); Yan JIANG, Beijing (CN)

(21) Appl. No.: 19/167,849

(22) PCT Filed: Mar. 13, 2024
(86) PCT No.: PCT/CN2024/081483

§ 371 Date: Sep. 23, 2025

(30) Foreign Application Priority Data
Mar. 30, 2023 (CN) 202310332658.1

(51) Int. Cl. H04L 51/043; G06F 3/04855; G06Q 10/101

(52) U.S. Cl. CPC H04L 51/043; G06F 3/04855; G06Q 10/101

(57) ABSTRACT

Embodiments of the present disclosure relate to a method, an apparatus, an electronic device, and a medium for presenting an instant message. The method comprises determining a presentation mode of an instant message in a collaborative document, wherein the presentation mode includes a card view or a link view. The method further comprises presenting the instant message to a user in the collaborative document according to the presentation mode. The method further comprises jumping to a window of a chat where the instant message is located in response to receiving a trigger on a jump link of the instant message.

### CROSS-REFERENCE TO RELATED APPLICATION(S)

The present application claims priority to Chinese Patent Application No. 202310332658.1, filed on Mar. 30, 2023, and entitled “METHOD AND APPARATUS FOR INSTANT MESSAGE PRESENTATION, AND ELECTRONIC DEVICE AND MEDIUM”, which is incorporated herein by reference in its entirety.

### FIELD

Embodiments of the present disclosure relate to the field of computer, and in particular, to a method, an apparatus, an electronic device, and a medium for presenting an instant message.

### BACKGROUND

With the technology of a collaborative document, a document can be shared to a cloud, and multi-user online editing can be realized, and changed content can be synchronized in real time. The collaborative document supports multi-user collaborative editing, and has functions such as seeing changes of others in real time, automatically saving online, and automatically synchronizing at multiple terminals. The collaborative document can be more convenient for team collaboration, and is suitable for lightweight mobile office.

Instant messaging (IM) is a service that allows two or more people to use a network to instantly deliver texts, pictures, files, voices, and videos for communication. The communication requirements of daily office work of many enterprises can also be completed in instant messaging software, for example, through communications of a one-to-one single chat or a group chat.

### SUMMARY

Embodiments of the present disclosure provide a method, an apparatus, an electronic device, and a computer-readable storage medium for presenting an instant message.

According to a first aspect of the present disclosure, a method for presenting an instant message is provided. The method comprises determining a presentation mode of an instant message in a collaborative document, wherein the presentation mode includes a card view or a link view; presenting the instant message to a user in the collaborative document according to the presentation mode; and jumping to a window of a chat where the instant message is located in response to receiving a trigger on a jump link of the instant message.

According to a second aspect of the present disclosure, an apparatus for presenting an instant message is provided. The apparatus comprises a presentation mode determination module configured to determine a presentation mode of an instant message in a collaborative document, wherein the presentation mode comprises a card view or a link view; an instant message presentation module configured to present the instant message to a user in the collaborative document according to the presentation mode; and a chat window jump module configured to jump to a window of a chat where the instant message is located in response to receiving a trigger on a jump link of the instant message.

According to a third aspect of the present disclosure, an electronic device is provided. The electronic device includes a processor and a memory coupled to the processor. The memory has instructions stored therein, and the instructions, when executed by the processor, cause the electronic device to perform the method according to the first aspect.

According to a fourth aspect of the present disclosure, a computer-readable storage medium is provided. The computer-readable storage medium has one or more computer instructions stored thereon, and the one or more computer instructions are executed by a processor to implement the method according to the first aspect.

The Summary section is provided to introduce a selection of concepts in a simplified form, which will be further described in Detail Description section below. The Summary section is not intended to identify key features or essential features of the subject matter claimed, nor is it intended to limit the scope of the subject matter claimed.

### BRIEF DESCRIPTION OF THE DRAWINGS

The above-mentioned and other features, advantages, and aspects of embodiments of the present disclosure will become more apparent when taken in conjunction with the drawings and with reference to the following detailed description. In the drawings, the same or similar reference numerals refer to the same or similar elements, where:

FIG. 1 is a schematic diagram of an example environment in which a method for presenting an instant message according to some embodiments of the present disclosure can be implemented;

FIG. 2 is a flowchart of a method for presenting an instant message according to some embodiments of the present disclosure;

FIG. 3 is a flowchart of a process of generating a collaborative document including an instant message according to some embodiments of the present disclosure;

FIG. 4 is a flowchart of a process of authenticating presentation of an instant message to a user according to some embodiments of the present disclosure;

FIG. 5 is a schematic diagram of a group chat according to some embodiments of the present disclosure;

FIG. 6 is a schematic diagram of a single chat according to some embodiments of the present disclosure;

FIG. 7 is a schematic diagram of a card view according to some embodiments of the present disclosure;

FIG. 8A is a schematic diagram of a first part of an instant message in a card view according to some embodiments of the present disclosure;

FIG. 8B is a schematic diagram of a second part of an instant message in a card view according to some embodiments of the present disclosure;

FIG. 9 is a schematic diagram of a card view in which a user is not in a group chat according to some embodiments of the present disclosure;

FIG. 10 is a schematic diagram of a card view in which a user is in a single chat according to some embodiments of the present disclosure;

FIG. 11 is a schematic diagram of a card view in which a user is not in a single chat according to some embodiments of the present disclosure;

FIG. 12 is a schematic diagram of a link view according to some embodiments of the present disclosure;

FIG. 13 is a schematic diagram of a link view in which a user is not in a chat according to some embodiments of the present disclosure;

FIG. 14 is a block diagram of an apparatus for presenting an instant message according to some embodiments of the present disclosure; and

FIG. 15 is a block diagram of a device for presenting an instant message according to some embodiments of the present disclosure.

In all the drawings, the same or similar reference numerals refer to the same or similar elements.

### DETAILED DESCRIPTION OF EMBODIMENTS

It may be understood that data involved in the technical solution (such as chat messages, including but not limited to data itself, data acquisition, or data use) should comply with requirements of corresponding laws, regulations, and related provisions.

Embodiments of the present disclosure will be described in more detail below with reference to the drawings. Although some embodiments of the present disclosure are shown in the drawings, it should be understood that the present disclosure may be implemented in various forms, and should not be construed as limited to the embodiments set forth herein. On the contrary, these embodiments are provided for a more thorough and complete understanding of the present disclosure. It should be understood that the drawings and embodiments of the present disclosure are only used for illustration and are not intended to limit the protection scope of the present disclosure.

In the description of the embodiments of the present disclosure, the term “include/comprise” and similar terms should be understood as open inclusion, that is, “include/comprise but not limited to”. The term “based on” should be understood as “based on at least in part”. The term “an embodiment” or “the embodiment” should be understood as “at least one embodiment”. The terms “first” and “second” may refer to different or the same objects. Other explicit and implicit definitions may also be included below.

In work and life, scenarios where instant messages need to be synchronized to collaborative documents are frequently encountered. At present, the full picture of an instant message can only be completely presented by means of a screenshot, and the full picture may include an avatar of the publisher of the instant message, the date and time of publishing, comments on the instant message, content of the instant message, and the like. However, the screenshot may be not clear, or the size of the screenshot may be not large enough, so that multiple screenshots may be needed, resulting in a poor layout.

To solve the above-mentioned disadvantages, embodiments of the present disclosure provide a solution for presenting an instant message. The solution may provide a method for combining the full picture of an instant message into a collaborative document, and provide that the chat window of the original instant message can be jumped back by clicking the instant message. Therefore, operation steps are reduced, user experience is improved, and the circulation of messages is enhanced to a certain extent while user requirements are satisfied.

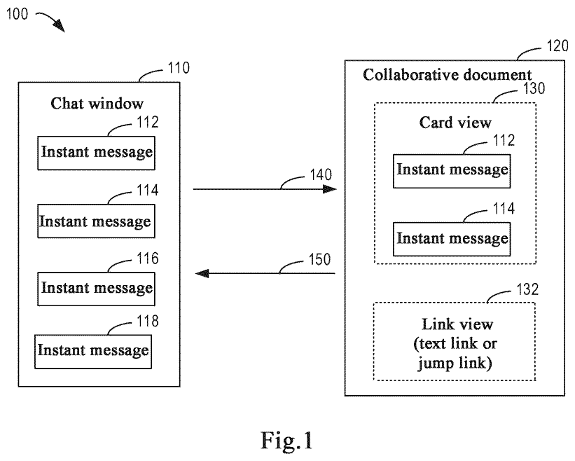

The present disclosure will be described below in conjunction with FIG. 1 to FIG. 15. However, it should be understood that this is only for those skilled in the art to better understand the principles and ideas of the embodiments of the present disclosure, and is not intended to limit the scope of the present disclosure in any way.

FIG. 1 is a schematic diagram of an example environment 100 in which a method for presenting an instant message according to some embodiments of the present disclosure can be implemented. As shown in FIG. 1, the example environment 100 may include a chat window 110 and a collaborative document 120. The chat window 110 and the collaborative document 120 may run on any electronic device such as a mobile terminal, a smart phone, a desktop computer, a laptop computer, a tablet phone, and the like.

The chat window 110 may be a single chat window, and the single chat includes a chat with a user or a chat with a robot assistant. The chat window 110 may also be a group chat window, and the group chat includes a chat with a plurality of users or a chat with a plurality of users and a robot assistant. The chat window 110 may also be a topic chat window for a certain topic, and the topic chat includes a topic main post or a reply post replying to the topic main post. The chat window 110 may include a plurality of instant messages, for example, an instant message 112, an instant message 114, an instant message 116, and an instant message 118. Publishers of instant messages may be the same or different. It may be understood that more or fewer instant messages may be included in the chat window 110. The instant message may also include a comment reply thereto, for example, an expression representing the following: like, +1, thumbs up, laugh and cry, OK, or others. The chat window 110 may further include a message with a reply nesting structure, and the reply nesting structure refers to combining the content of a first message and the content of a reply message into one message and displaying this message after the first message is replied by reference. The chat window 110 may further include a status identifier of a message which is edited again after being sent, for example, “edited” is displayed after the message.

The collaborative document 120 acquires instant messages, for example, receiving an action 140 of pasting the instant message 112 and the instant message 114. After acquiring the instant message 112 and the instant message 114, the instant message 112 and the instant message 114 may be presented as a card view 130 or a link view 132. In the card view 130, the full picture or a part of the full picture of the instant message 112 and the instant message 114 will be presented. The full picture may be presented in the form of a previewable card. The previewable card may include one or more of an avatar of a publisher, a name, a publishing time, a date, a comment on the message, and the like. In the link view 132, the instant message 112 and the instant message 114 will be presented as jump links.

If a selection (for example, a click in a touchscreen) of a user for the instant message 112 or the instant message 114 is received, and it is determined that the user is in the chat window 110 where the instant message 112 or the instant message 114 is located, and the chat window 110 may be jumped to (150). If it is determined that the user is not in the chat window 110, the user may be prompted that the user cannot jump, and a reason why the user cannot jump is further prompted, i.e., the user is not in the chat window 110.

In some embodiments, the chat may include a single chat, a private group chat, and a public group chat. The single chat is a one-to-one chat between users. The private group chat is a group chat including two or more members, and only users invited by group members or group administrators can enter the private group chat, and non-group members cannot actively join the private group chat. The public group chat is a group chat including two or more members, and anyone in an organization can find the public group chat by searching for a group name and information in the group, and can actively join the chat. In addition, when a link of the public group is obtained, the public group chat can also be joined by clicking on the link. On this basis, if the link is the single chat or the private group chat, when the user clicks on the link of the instant message in the document and the user is a member in the chat, the chat window may be jumped to. If the user is not a member in the chat, the jump is refused. If the link is the public group chat, when the user clicks on the link of the instant message in the document, the user can directly jump to the chat window.

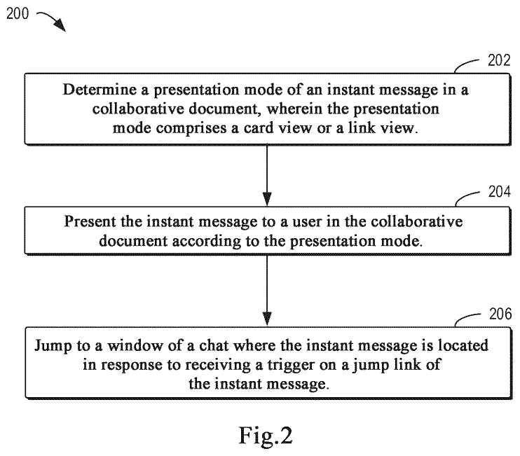

FIG. 2 is a flowchart of a method 200 for presenting an instant message according to some embodiments of the present disclosure. The method 200 will be described below in conjunction with FIG. 1 and FIG. 2. At block 202, a presentation mode of an instant message in a collaborative document is determined, wherein the presentation mode comprises a card view or a link view. As an example, one or more of the instant message 112, the instant message 114, the instant message 116, and the instant message 118 may be selected, and the selected instant message may be pasted into the collaborative document 120. When pasting the selected one or more instant messages, it may be determined whether to use the card view 130 or the link view 132. For simplification of description, it is assumed here that a user A selects the instant message 112 and the instant message 114 and pastes them into the collaborative document 120, which will be described below according to this assumption.

At block 204, the instant message is presented to the user in the collaborative document according to the presentation mode. As an example, if the card view 130 is selected for use when the instant message 112 and the instant message 114 are pasted, the instant message 112 and the instant message 114 may be displayed in the form of the card view. If the link view 132 is selected for use when the instant message 112 and the instant message 114 are pasted, the instant message 112 and the instant message 114 may be displayed in the form of the link view.

At block 206, a window of a chat where the instant message is located is jumped to in response to receiving a trigger on a jump link of the instant message. As an example, if a user B is editing the collaborative document 120 and clicks on the instant message 112 or the instant message 114, and the user B is also in the chat window 110, then it may jump to the chat window 110. In some embodiments, if the chat window 110 is not opened, then the chat window 110 may be popped up, and the collaborative document 120 is kept in an open state. In some embodiments, the instant message 110 may be located in the chat window 110, and the instant message 110 may be highlighted.

By implementing the method 200, the instant message may be presented in the collaborative document, and if the user is in the chat where the instant message is located, then the chat where the instant message is located can be jumped back to, so that the user does not need to further search for the chat window, and thus operation steps can be reduced, and user experience can be improved.

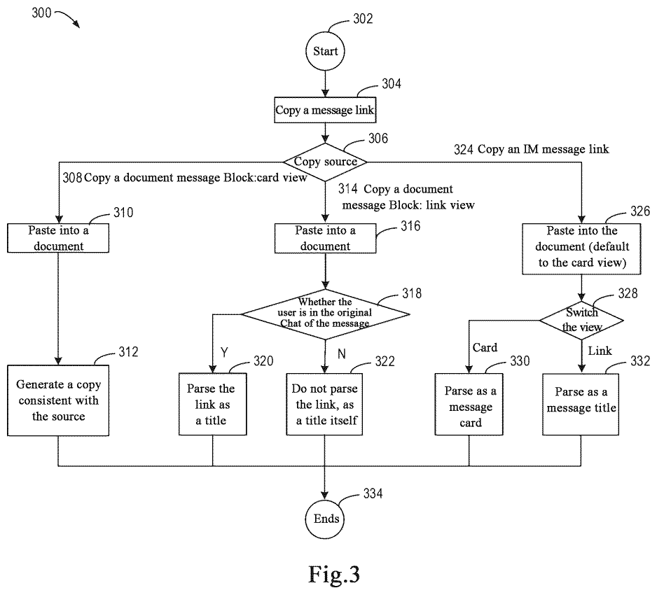

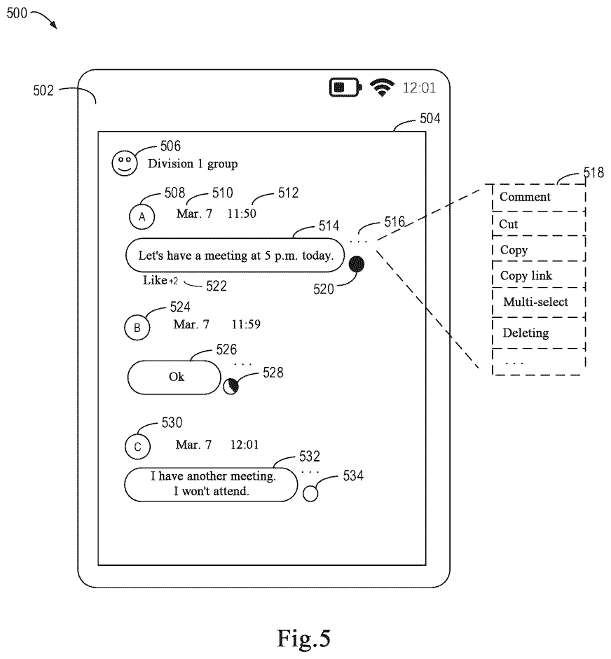

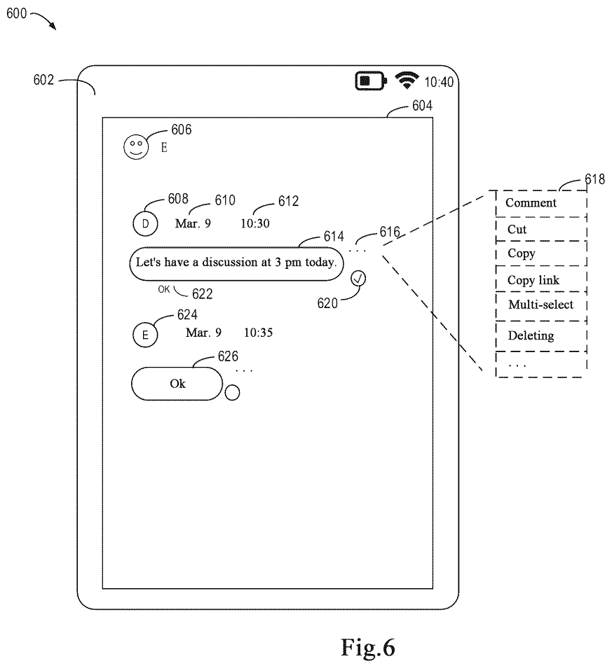

FIG. 3 is a flowchart of a process 300 of generating a collaborative document including an instant message according to some embodiments of the present disclosure. The process 300 as shown in FIG. 3 is a process of pasting an instant message into a collaborative document and determining different permissions from a perspective of a generator (for example, the user A mentioned above). The process 300 starts at block 302. At block 304, an action of selecting an instant message and copying the instant message is received. The instant message may come from a group chat or a single chat, or other collaborative documents. In some embodiments, copying the instant message includes copying a link of the instant message. The link may be understood as an anchor point, and a specific location of the instant message in its original chat, that is, an original location of the instant message, can be located through the link. The types of the original chat include a group chat and a single chat, and the group chat and the single chat will be described below in conjunction with FIG. 5 and FIG. 6.

FIG. 5 is a schematic diagram of a group chat 500 according to some embodiments of the present disclosure. The group chat 500 is presented in a screen 502 of an electronic device, for example, in an area 504 in the screen 502. At the top of the group chat 500, a name 506 of the group chat may be included, for example, “division 1 group”. The group chat 500 may also include a plurality of instant messages, such as an instant message 514, an instant message 526, and an instant message 532. Above the instant message 514, an avatar of a publisher 508 of the instant message 514 may also be included.

Next to the avatar of the publisher 508, a date 510 and a time 512 of publishing may also be included. Next to the instant message 514, an icon 516 representing more operations may also be included. If the icon 516 is clicked or hovered over, a box 518 representing more operations may also be presented, such as operations such as commenting, cutting, copying, copying a link, multi-selecting, and deleting. Below the instant message 514, a comment 522 on the instant message 514 may also be included, for example, a like. Below the instant message 514, a reading status icon 520 may also be included, for example, a solid icon represents that all recipients have read the message.

It may be understood that the date 510, the time 512, the icon 516, the comment 522, the reading status icon 520, and the like presented around the instant message 514 may change positions as required, or may not always be presented, but appear in response to the mouse moving to a position near the instant message.

Similarly, the group chat 500 may further include an instant message 526 and an avatar of a publisher 524 thereof, and may also include an icon presented around the instant message 526 as the instant message 514, which will not be described here again. A reading status icon 528 of the instant message 526 represents that a part of users have read the instant message 526, and the larger the proportion of black, the more users who have read the instant message 526.

Similarly, the group chat 500 may further include an instant message 532 and an avatar of a publisher 530 thereof, and may also include an icon presented around the instant message 532 as the instant message 514 or the instant message 526, which will not be described here again. A reading status icon 534 of the instant message 532 is hollow, representing that the instant message 532 has not been read, i.e., no other user has read the instant message 532 yet.

FIG. 6 is a schematic diagram of a single chat 600 according to some embodiments of the present disclosure. The single chat 600 may be presented in a screen 602 of an electronic device, for example, in an area 604 in the screen 602. At the top of the single chat 600, a name of an object of the single chat may be included. For example, the single chat 600 is a chat window between a user D and a user E, and the single chat 600 is from a perspective of a chat window of the user D, and a name of the user E may be displayed at a name 606.

The single chat 600 may further include a plurality of instant messages, such as an instant message 614 and an instant message 626. Above the instant message 614, an avatar of a publisher 608 of the instant message 614 may also be included. Next to the avatar of the publisher 608, a date 610 and a time 612 of publishing may also be included. Next to the instant message 614, an icon 616 representing more operations may also be included. If the icon 616 is clicked or hovered over, a box 618 representing more operations may also be presented, for example, operations such as commenting, cutting, copying, copying a link, multi-selecting, and deleting. Below the instant message 614, a comment 622 on the instant message 614 may also be included, for example, OK. Below the instant message 614, a reading status icon 620 may also be included, for example, a circular icon with a checkmark inside represents that the instant message 614 has been read.

Similarly, the single chat 600 may further include an instant message 626 and an avatar of a publisher 624 thereof, and may also include an icon presented around the instant message 626 as the instant message 614, which will not be described here again.

Returning to FIG. 3, at block 306, a source of the instant message is determined. If the source of the instant message is a source 308, that is, the instant message that has been copied in another document, and the instant message is pasted to be presented in the card view, the process 300 proceeds to block 310. If the source of the instant message is a source 314, that is, the instant message that has been copied in another document, and the instant message is pasted to be presented in the link view, the process 300 proceeds to block 316. In some embodiments, if the source of the instant message is the current collaborative document, and in the case of copying a message link from the current collaborative document, the content of the text link generated after pasting is still “from XX chat”, where XX represents the current collaborative document. If the source of the instant message is a source 324, that is, the instant message in the chat, the process 300 proceeds to block 326.

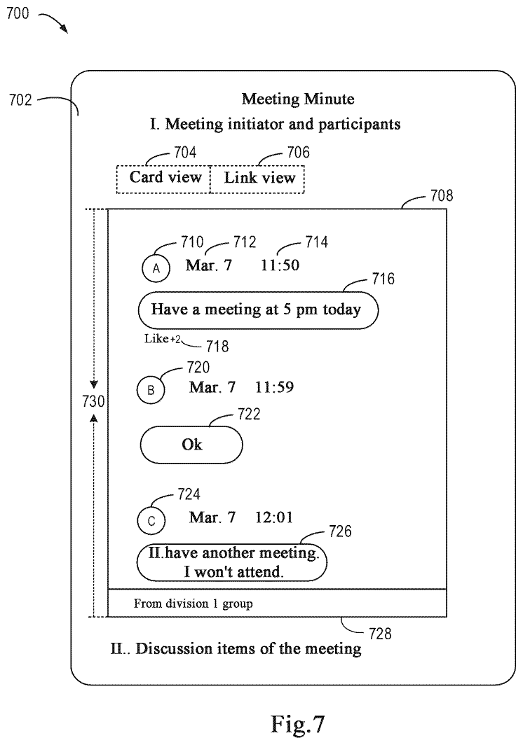

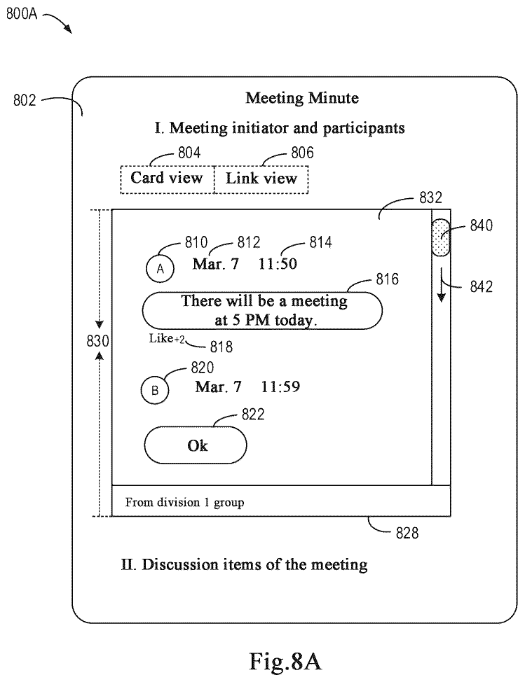

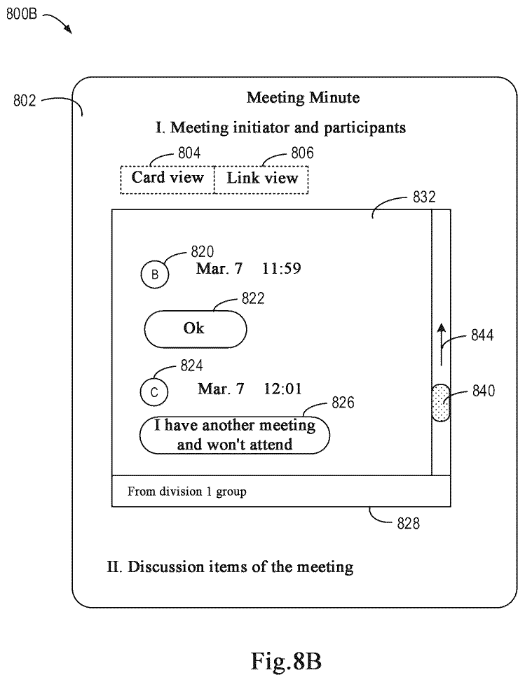

To better understand the card view and the link view, the card view will be described below in conjunction with FIG. 7 to FIG. 8B. FIG. 7 is a schematic diagram of a card view 700 according to some embodiments of the present disclosure. The collaborative document 702 may include a card view icon 704 determined to be presented in the card view and a link view icon 706 presented in the link view. The presentation mode can be switched by selecting the card view icon 704 or selecting the link view icon 706. It may be understood that the card view icon 704 or the link view icon 706 may not need to be always presented in the collaborative document, and may be presented in response to a mouse or a finger being already in an activation region. If the mouse or the finger is not in the activation region, the card view icon 704 or the link view icon 706 is not presented.

The collaborative document 702 may include a predetermined presentation region 708. The predetermined presentation region 708 may be used to present the instant message pasted into the collaborative document 702. For example, the instant message 716, the instant message 722, and the instant message 726 are pasted into the collaborative document 702. A publisher 710, a publishing date 712, a publishing time 714, and a comment 718 may also be included around the instant message 716.

Similarly, a publisher 720 and other information or icons (not shown) may also be included around the instant message 722, and a publisher 724 and other information or icons (not shown) may also be included around the instant message 726. At the bottom of the predetermined presentation region 708, a source 728 of the instant message may also be included, for example, the source of the instant message 716, the instant message 722, and the instant message 726 is the division 1 group.

The predetermined presentation region 708 has a threshold height 730, for example, the threshold height may be determined in pixels. If the pixel threshold required to present the instant message is less than or equal to the threshold height, the instant message may be completely presented in the predetermined presentation region 708. If the threshold required to present the instant message is greater than the threshold height, a part of the instant message may be presented in the predetermined presentation region 708.

FIG. 8A is a schematic diagram of a first part 800A of an instant message in a card view according to some embodiments of the present disclosure. The collaborative document 802 may include a card view icon 804 for presenting the instant message in the card view and a link view icon 806 for presenting the instant message in the link view. Similarly, the presentation mode can be switched by selecting the card view icon 804 or selecting the link view icon 806. In the collaborative document 802, a threshold height 830 of a predetermined presentation region 832 is less than a pixel height required to present the entire instant message. Then, as an example, it may be determined that the instant message 816 and the instant message 822 (also referred to as the first part) are presented in the predetermined presentation region 832. A side scroll bar 840 may be generated. The side scroll bar 840 may be initially located at the top and may be pulled down (842) to a lower position.

FIG. 8B is a schematic diagram of a second part 800B of an instant message in a card view according to some embodiments of the present disclosure. In FIG. 8B, the side scroll bar 840 has been pulled down to a lower position and may be pulled up (844) to a higher position. Under the control of the side scroll bar 840, it may be determined that the instant message 822 and the instant message 826 (also referred to as the second part) are presented in the predetermined presentation region 832. It may be understood that in the case where there are more instant messages, a change in presentation content that can be controlled as the side scroll bar slides for a certain distance (for example, one pixel) may be re-determined.

Returning to FIG. 3, at block 310, the instant message pasted into the collaborative document is received. At block 312, a copy of the instant message consistent with the source 308 is generated. At block 316, the pasting of the instant message is received. At block 318, whether the user is in an original chat of the instant message is determined. If the user is in the original chat of the instant message, the process 300 proceeds to block 320. At block 320, the message link is parsed as a title of the message for use as the text link (for example, the source 728 in FIG. 7). If the user is not in the original chat of the instant message, the process 300 proceeds to block 322. At block 322, the message link is not parsed as the text link, and the jump link (also referred to as a bare link) is directly presented.

At block 326, the pasting of the instant message is received, and it is default that the instant message will be presented in the card view. At block 328, whether there is an action of switching the view is determined. If there is an action of switching the card view to the link view, the process 300 proceeds to block 332. If there is no action of switching the card view to the link view, the process 300 proceeds to block 330. At block 330, the instant message is parsed as a message card and presented in the collaborative document. At block 332, the instant message is parsed as a message title and presented in the collaborative document. At block 334, the process 300 ends.

By implementing the process 300, the message may be linked and copied into the collaborative document. The collaborative document has the capability of parsing the message link, and the instant message may be presented according to the presentation mode. In this way, the message is combined into the document, the circulation of the message is enhanced, and the threshold for message circulation is reduced. In addition, since the full picture of the message can be maintained, the readability of the instant message in the document is better.

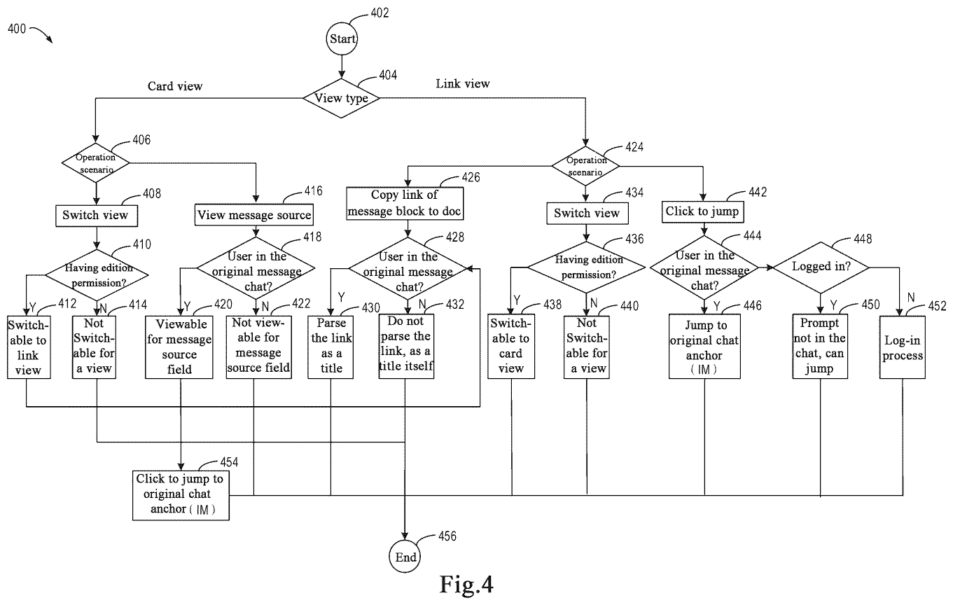

FIG. 4 is a flowchart of a process 400 of authenticating presentation of an instant message to a user according to some embodiments of the present disclosure. The process 400 as shown in FIG. 4 is a process of reading and editing the instant message in the collaborative document from a perspective of a user (for example, the user B mentioned when describing FIG. 2) who edits the collaborative document. The process 400 starts at block 402. At block 404, a presentation mode of the instant message is determined. If the presentation mode is the card view, the process 400 proceeds to block 406. If the presentation mode is the link view, the process 400 proceeds to block 424.

At block 406, an operation scenario is determined. For example, if the user selects to switch the view, which belongs to a scenario of switching the view, the process 400 proceeds to block 408. If the user clicks on the instant message, which belongs to a scenario of viewing the source of the message, the process 400 proceeds to block 416. At block 408, it is determined that the current operation is to switch the view. At block 410, whether the user has permission to edit the collaborative document is determined. If the user has permission to edit the collaborative document, the process 400 proceeds to block 412. At block 412, the presentation mode may be switched from the card view to the link view, and the process 400 proceeds to block 428. If the user does not have permission to edit the collaborative document, the process 400 proceeds to block 414. At block 414, it is determined that the presentation mode cannot be switched from the card view to the link view, and a reason may also be prompted to the user.

At block 416, it is determined that the current operation is to view the source of the message. At block 418, whether the user is in the original chat of the instant message is determined. If the user is in the original chat of the instant message, the process 400 proceeds to block 420. At block 420, the source of the message may be presented in the card view. At block 454, in response to the user clicking on the instant message presented in the card view, the process 400 may proceed to block 452.

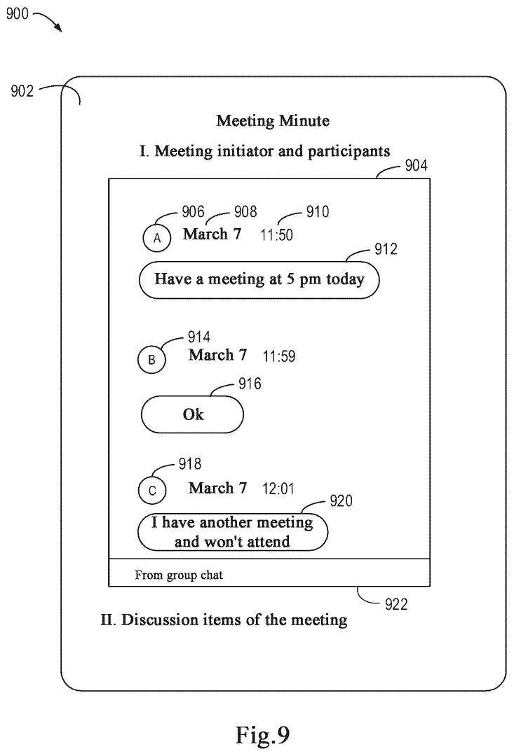

If the user is not in the original chat of the instant message, the process 400 proceeds to block 422. At block 422, the specific source of the message is not presented in the card view. For example, the name of the group chat from which the message comes is not presented, but only “from group chat” is presented. The difference between presenting the source of the message and not presenting the source of the message in the card view will be described below in conjunction with FIG. 9.

FIG. 9 is a schematic diagram of a card view 900 in which the user is not in a group chat according to some embodiments of the present disclosure. The collaborative document 902 may include a predetermined presentation region 904. The predetermined presentation region 904 may be used to present the instant message pasted into the collaborative document 902. For example, the instant message 912, the instant message 916, and the instant message 920 are pasted into the collaborative document 902. A publisher 906, a publishing date 908, and a publishing time 910 may also be included around the instant message 912.

Similarly, a publisher 914 and other information or icons (not shown) may also be included around the instant message 916, and a publisher 918 and other information or icons (not shown) may also be included around the instant message 920. At the bottom of the predetermined presentation region 904, the specific source of the instant message 912, the instant message 916, and the instant message 920 is not presented, but only the group chat from which the messages come is presented (at block 922). For clearer understanding, the example in FIG. 7 may also be reviewed, for example, the source 728 of the instant message presented in FIG. 7, which shows a specific name of the source, for example, the division 1 group.

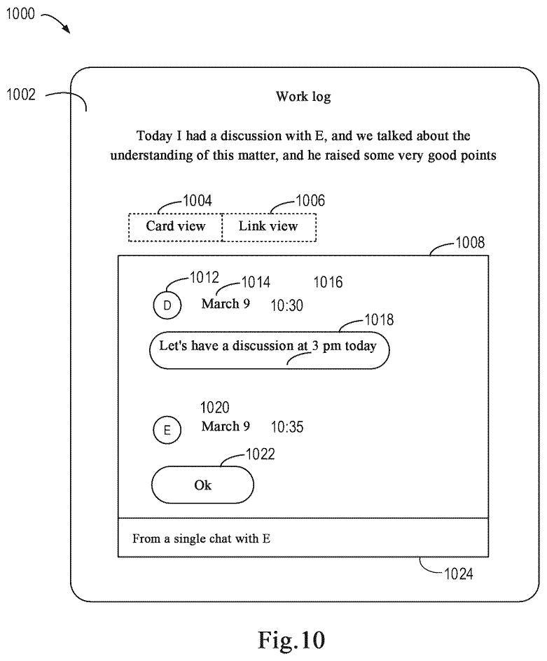

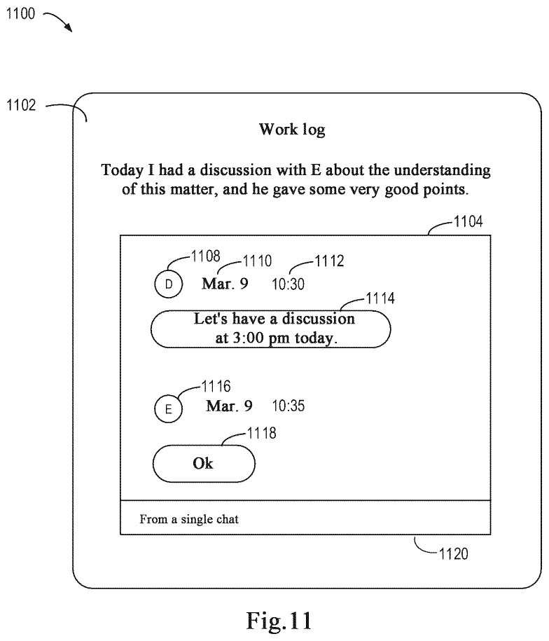

If the instant message comes from a single chat, the difference between presenting the source of the message and not presenting the source of the message in the card view for the single chat may be understood in conjunction with FIG. 10 and FIG. 11. FIG. 10 is a schematic diagram of a card view 1000 in which the user is in a single chat according to some embodiments of the present disclosure. The collaborative document 1002 may include a card view icon 1004 for presenting in the card view and a link view icon 1006 for presenting in the link view. The presentation mode can be switched by selecting the card view icon 1004 or selecting the link view icon 1006. It may be understood that the card view icon 1004 or the link view icon 1006 may not need to be always presented in the collaborative document, and may be presented in response to a mouse or a finger being already in an activation region. If the mouse or the finger is not in the activation region, the card view icon 1004 or the link view icon 1006 is not presented.

The collaborative document 1002 may include a predetermined presentation region 1008. The predetermined presentation region 1008 may be used to present the instant message pasted into the collaborative document 1002. For example, the instant message 1018 and the instant message 1022 are pasted into the collaborative document 1002. A publisher 1012, a publishing date 1014, and a publishing time 1016 may also be included around the instant message 1018.

Similarly, a publisher 1020 and other information or icons (not shown) may also be included around the instant message 1022, and the specific source of the instant message 1018 and the instant message 1022 is presented at the bottom of the predetermined presentation region 1008, for example, a group chat with E (at block 1024).

FIG. 11 is a schematic diagram of a card view 1100 in which the user is not in a single chat according to some embodiments of the present disclosure. The collaborative document 1102 may include a predetermined presentation region 1104. The predetermined presentation region 1104 may be used to present the instant message pasted into the collaborative document 1102. For example, the instant message 1114 and the instant message 1118 are pasted into the collaborative document 1102. A publisher 1108, a publishing date 1110, and a publishing time 1112 may also be included around the instant message 1114.

Similarly, a publisher 1116 and other information or icons (not shown) may also be included around the instant message 1118, and the specific source of the instant message 1114 and the instant message 1118 is not presented at the bottom of the predetermined presentation region 1104, but only the single chat from which the messages come is presented (at block 1120).

Returning to FIG. 4, at block 424, the operation scenario is determined. If the scenario is that the user pastes the message link into the collaborative document, or copies the message link from another document to the collaborative document, the process 400 proceeds to block 426. If the scenario is to switch the view, for example, an action of switching the view by the user is received, the process 400 proceeds to block 434. If the scenario is to click and jump, for example, the user clicks on the instant message, the process 400 proceeds to block 442.

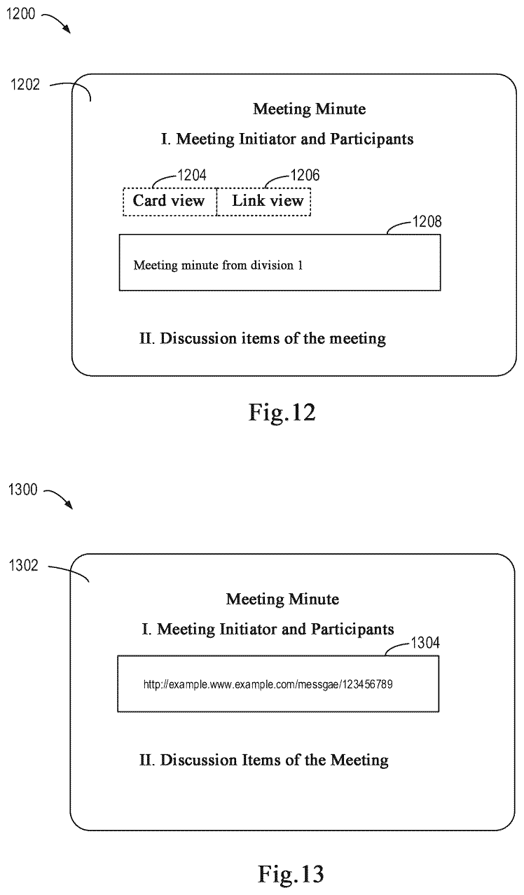

At block 426, it is determined that the operation scenario is to copy the message link to the collaborative document. At block 428, whether the user is in the original chat of the instant message is determined. If it is determined that the user is in the original chat of the instant message, the process 400 proceeds to block 430. If it is determined that the user is not in the original chat of the instant message, the process 400 proceeds to block 432. At block 430, the message link may be parsed as a title and presented in the form of the text link. At block 432, the message link may not be parsed as the text link, and the jump link is directly presented. The text link and the jump link will be described below in conjunction with FIG. 12 and FIG. 13.

FIG. 12 is a schematic diagram of a link view 1200 according to some embodiments of the present disclosure. The collaborative document 1202 may include a card view icon 1204 and a link view icon 1206. In FIG. 12, the link view icon 1206 is selected, so the text link 1208 is presented in the collaborative document 1202. The text link 1208 is presented in text, which may represent the name of the specific source of the instant message. If the mouse hovers over the text link 1208, an icon of more operations may be presented. If the text link is clicked, it is possible to jump to the original chat window of the instant message with permission. FIG. 13 is a schematic diagram of a link view 1300 in which the user is not in the chat according to some embodiments of the present disclosure. In the collaborative document 1302, the jump link 1304 is presented in the form of a Uniform Resource Locator (URL) address. If the URL link is clicked, it is possible to jump to the original chat window of the instant message with permission.

Returning to FIG. 4, at block 434, it is determined that the scenario is to switch the view. At block 436, whether the user has permission to edit the collaborative document is determined. If the user has permission to edit the collaborative document, the process 400 proceeds to block 438. If the user does not have permission to edit the collaborative document, the process 400 proceeds to block 440. At block 438, the presentation mode of the instant message is switched to the card view. At block 440, the view is not switched. In some embodiments, a reason why the view cannot be switched may also be prompted to the user.

At block 442, it is determined that the scenario is clicking to jump. At block 444, whether the user is in the original chat of the instant message is determined. If it is determined that the user is in the original chat of the instant message, the process 400 proceeds to block 446. If it is determined that the user is not in the original chat of the instant message, or cannot be determined, the process 400 proceeds to block 448. At block 446, the original chat window where the instant message is located is jumped to the corresponding position (anchor point). In some embodiments, the instant message may also be highlighted in the original chat window.

At block 448, whether the user has logged in to the account of the collaborative document or the account of the instant messaging software is determined. In some embodiments, the two may be the same account, or the instant message and the collaborative document may use the same software, and the two are different functions or services of the software. If it is determined that the user has logged in, the process 400 proceeds to block 450. If it is determined that the user has not logged in, the process 400 proceeds to block 452. At block 450, the user is prompted that the user is not in the chat where the instant message is located and cannot jump. At block 452, the user is prompted to log in. At block 456, the process 400 ends.

By implementing the process 400, a user with permission to edit the document can view the corresponding instant message according to the permission, so that it is safer. The user with the edit permission may flexibly switch the presentation mode to a card or a link, and the viewing effect of other viewers will also change synchronously after the operation, thereby providing a more personalized user experience.

In some embodiments, in the case where the link of the instant message is acquired from the chat window, a message content block may be created, and the link of the instant message is parsed to acquire the message content. A link type of the link of the instant message may also be determined, and the message content block is converted into a message preview content block corresponding to the link type according to the link type and the message content.

In some embodiments, in the case where the link of the instant message is acquired from the collaborative document, one or more of three operations (1) to (3) may be performed. Operation (1) may include parsing the link into a text content block in response to a copy operation for the instant message in the collaborative document, wherein the text content block includes the link of the instant message. Operation (2) may include reading, through a message service, message data in a cache in response to pasting the instant message in a current collaborative document, and if the user has permission to read the instant message, generating and displaying a message content block according to the text content block; if the user does not have permission to read the instant message, displaying the link of the instant message. Operation (3) may include acquiring, through a message service, message data from an instant messaging client in response to pasting the instant message in another collaborative document, and if the user has permission to read the instant message, generating and displaying a message content block according to the text content block; if the user does not have permission to read the instant message, displaying the link of the instant message.

In some embodiments, if a reply operation for the instant message presented in the collaborative document is triggered, a reply message is displayed in the collaborative document. In some embodiments, if the reply operation for the instant message presented in the collaborative document is received, one or more of operations (4) to (6) may be performed. Operation (4) may include generating, in response to an emoticon reply to a target message, emoticon information in a message entry of the target message, where the emoticon information is placed at the bottom of the message entry. Operation (5) may include displaying, in response to a reference reply to the target message, a message including content of the target message and content of a reply in the collaborative document. Operation (6) may include displaying, in response to a reply to the instant message, a new message including content of the reply in the collaborative document. In some embodiments, the method further includes synchronously displaying the reply message in a chat corresponding to the instant message.

In some embodiments, if the instant message is a topic message, a schedule message, or a workflow message, one or more of operations (7) to (9) are further included. Operation (7) may include displaying a reply message in the instant message presented in the collaborative document when a new reply message is generated for the topic message in the chat. Operation (8) may include displaying a status change in the instant message presented in the collaborative document when a new status change is generated for the schedule message in the chat. Operation (9) may include displaying a node message in the workflow message presented in the collaborative document when a new node message is generated for the workflow message in the chat. In some embodiments, the workflow message may be an approval process, an email loop, or the like. When a new approval matter is added to a certain node of the approval process, the generated matter change is synchronized to the document. Correspondingly, when a reply to the email is generated, the reply is synchronized.

In some embodiments, user identification information of a message sender may be further included in the instant message presented in the collaborative document. If a trigger operation is performed on the user identification information, a contact card of the user is displayed. If a trigger operation is performed on a preset control in the contact card, an instant messaging chat window with the user is displayed.

In some embodiments, if the instant message includes a link of a target collaborative document, whether a current user has read permission for the target collaborative document is determined. If the current user has the read permission for the target collaborative document, document preview information corresponding to the link is displayed in the instant message. If the current user does not have the read permission for the target collaborative document, the link is displayed in the instant message.

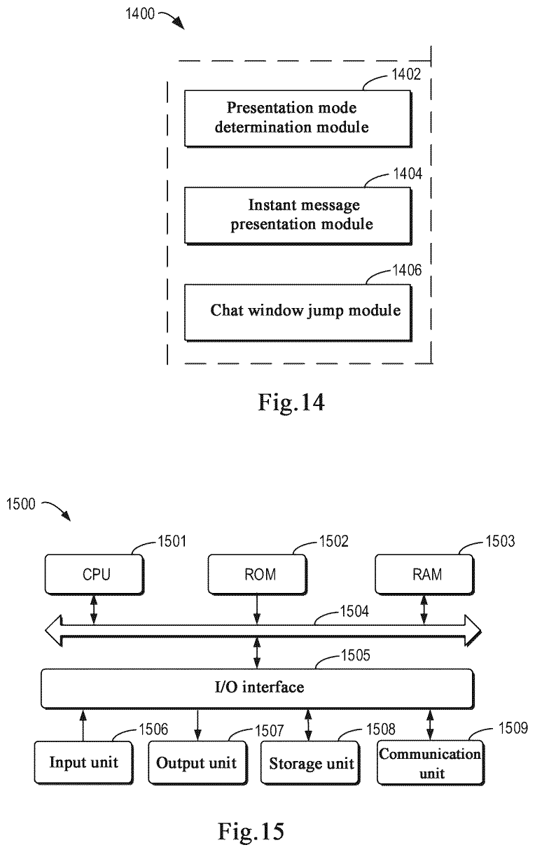

FIG. 14 is a block diagram of an apparatus 1400 for presenting an instant message according to some embodiments of the present disclosure. As shown in FIG. 14, the apparatus 1400 comprises a presentation mode determination module 1402 configured to determine a presentation mode of an instant message in a collaborative document, wherein the presentation mode includes a card view or a link view. The apparatus 1400 further comprises an instant message presentation module 1404 configured to present the instant message to a user in the collaborative document according to the presentation mode. The apparatus 1400 further comprises a chat window jump module 1406 configured to jump to a window of a chat where the instant message is located in response to receiving a trigger on a jump link of the instant message. The apparatus 1400 may further comprises other modules to implement the same functions as the method 200, which will not be described here again for simplicity.

It may be understood that through the apparatus 1400 of the present disclosure, at least one of the many advantages that can be achieved by the method or process described above may be achieved. For example, the original appearance of the instant message may be presented in the collaborative document, and if the user is in the chat where the instant message is located, the chat where the instant message is located can be jumped back to, so that the user does not need to further search for the chat window, and thus operation steps can be reduced, and user experience can be improved. In some embodiments, a user with the edit permission of the document may also flexibly switch the presentation mode to a card or a link, and the viewing effect of other viewers will also change synchronously after the operation, thereby providing a more personalized user experience.

FIG. 15 is a block diagram of a device 1500 for presenting an instant message according to some embodiments of the present disclosure, and the device 1500 may be a device or an apparatus described in the embodiments of the present disclosure. As shown in FIG. 15, the device 1500 includes a central processing unit (CPU) 1501, which may perform various appropriate actions and processing according to computer program instructions stored in a read-only memory (ROM) 1502 or computer program instructions loaded from a storage unit 1508 into a random access memory (RAM) 1503. The RAM 1503 may also store various programs and data required for the operation of the device 1500. The CPU 1501, the ROM 1502, and the RAM 1503 are connected to each other through a bus 1504. An input/output (I/O) interface 1505 is also connected to the bus 1504. Although not shown in FIG. 15, the device 1500 may also include a coprocessor.

Multiple components in the device 1500 are connected to the I/O interface 1505, including: an input unit 1506, such as a keyboard, a mouse, and the like; an output unit 1507, such as various types of displays, speakers, and the like; a storage unit 1508, such as a magnetic disk, an optical disk, and the like; and a communication unit 1509, such as a network card, a modem, a wireless communication transceiver, and the like. The communication unit 1509 allows the device 1500 to exchange information/data with other devices through a computer network such as the Internet and/or various telecommunication networks.

The various methods or processes described above may be executed by the CPU 1501. For example, in some embodiments, the method may be implemented as a computer software program, which is tangibly contained in a machine-readable medium, such as the storage unit 1508. In some embodiments, part or all of the computer program may be loaded and/or installed on the device 1500 via the ROM 1502 and/or the communication unit 1509. When the computer program is loaded into the RAM 1503 and executed by the CPU 1501, one or more steps or actions in the method or process described above may be executed.

In some embodiments, the methods and processes described above may be implemented as a computer program product. The computer program product may include a computer-readable storage medium having computer-readable program instructions loaded thereon for executing various aspects of the present disclosure.

The computer-readable storage medium may be a tangible device that can keep and store instructions used by the instruction executing device. The computer-readable storage medium may be, for example, but not limited to, an electrical storage device, a magnetic storage device, an optical storage device, an electromagnetic storage device, a semiconductor storage device, or any suitable combination thereof. More specific examples of the computer-readable storage medium (a non-exhaustive list) include: a portable computer disk, a hard disk, a random access memory (RAM), a read-only memory (ROM), an erasable programmable read-only memory (EPROM or flash memory), a static random access memory (SRAM), a portable compact disk read-only memory (CD-ROM), a digital versatile disk (DVD), a memory stick, a floppy disk, a mechanical encoding device, such as a punched card or a bump structure in a groove on which instructions are stored, and any suitable combination thereof. The computer-readable storage medium as used herein is not interpreted as a transient signal per se, such as a radio wave or other freely propagating electromagnetic wave, an electromagnetic wave propagating through a waveguide or other transmission medium (for example, an optical pulse through an optical fiber cable), or an electrical signal transmitted through a wire.

The computer-readable program instructions described herein may be downloaded from the computer-readable storage medium to various computing/processing devices, or downloaded to an external computer or an external storage device via a network such as the Internet, a local area network, a wide area network, and/or a wireless network. The network may include copper transmission cables, optical fiber transmission, wireless transmission, routers, firewalls, switches, gateway computers, and/or edge servers. A network adapter card or a network interface in each computing/processing device receives the computer-readable program instructions from the network and forwards the computer-readable program instructions for storage in a computer-readable storage medium in the respective computing/processing device.

The computer program instructions for executing operations of the present disclosure may be assembly instructions, instruction set architecture (ISA) instructions, machine instructions, machine-related instructions, microcode, firmware instructions, state setting data, or source code or object code written in any combination of one or more programming languages, and the programming languages include object-oriented programming languages and conventional procedural programming languages. The computer-readable program instructions may be executed entirely on a user's computer, partly on a user's computer, as a stand-alone software package, partly on a user's computer and partly on a remote computer, or entirely on a remote computer or server. In the case of the remote computer, the remote computer may be connected to the user's computer through any kind of network, including a local area network (LAN) or a wide area network (WAN), or may be connected to an external computer (for example, connected via the Internet using an Internet service provider). In some embodiments, an electronic circuit, such as a programmable logic circuit, a field programmable gate array (FPGA), or a programmable logic array (PLA), may be personalized by using state information of the computer-readable program instructions, and the electronic circuit may execute the computer-readable program instructions, thereby implementing various aspects of the present disclosure.

These computer-readable program instructions may be provided to a processing unit of a general-purpose computer, a special-purpose computer, or other programmable data processing apparatus to produce a machine, such that the instructions, when executed by the processing unit of the computer or the other programmable data processing apparatus, cause the apparatus to implement the functions/actions specified in one or more blocks in the flowcharts and/or block diagrams. These computer-readable program instructions may also be stored in a computer-readable storage medium, and these instructions cause the computer, the programmable data processing apparatus, and/or other devices to work in a specific manner, so that the computer-readable medium storing the instructions includes an article of manufacture, which includes instructions for implementing various aspects of the functions/actions specified in one or more blocks in the flowcharts and/or block diagrams.

These computer-readable program instructions may also be loaded onto a computer, other programmable data processing apparatus, or other devices, such that a series of operational steps are performed on the computer, the other programmable data processing apparatus, or the other devices to produce a computer-implemented process, so that the instructions executed on the computer, the other programmable data processing apparatus, or the other devices implement the functions/actions specified in one or more blocks in the flowcharts and/or block diagrams.

The flowcharts and block diagrams in the drawings show the architecture, functionality, and operation of possible implementations of devices, methods, and computer program products according to multiple embodiments of the present disclosure. In this regard, each block in the flowcharts or block diagrams may represent a module, a program segment, or a part of instructions, and the module, the program segment, or the part of instructions includes one or more executable instructions for implementing specified logical functions. In some alternative implementations, the functions marked in the blocks may also occur in an order different from those marked in the drawings. For example, two consecutive blocks may actually be executed basically in parallel, and they may sometimes be executed in a reverse order, depending on the functions involved. It should also be noted that each block in the block diagrams and/or flowcharts and a combination of blocks in the block diagrams and/or flowcharts may be implemented by a dedicated hardware-based system that performs specified functions or actions, or may be implemented by a combination of dedicated hardware and computer instructions.

Various embodiments of the present disclosure have been described above, and the above description is exemplary, not exhaustive, and is not limited to the disclosed embodiments. Many modifications and changes will be apparent to those of ordinary skill in the art without departing from the scope and spirit of the embodiments described. The choice of terms used herein is intended to best explain the principles, practical applications, or technical improvements to the technology in the market of the embodiments, or to enable other ordinary skilled in the art to understand the embodiments disclosed herein.

Some example implementations of the present disclosure are listed below.

Example 1. A method of presenting an instant message, including:
determining a presentation mode of an instant message in a collaborative document, where the presentation mode includes a card view or a link view;
presenting the instant message to a user in the collaborative document according to the presentation mode; and
jumping to a window of a chat where the instant message is located in response to receiving a trigger on a jump link of the instant message.

Example 2. The method of example 1, wherein the card view includes a previewable card rendered based on content of the instant message, and the previewable card further includes a text link generated based on a source of the instant message, and the text link is associated with the jump link.

Example 3. The method according to examples 1-2, wherein the link view includes a text link generated based on a source of the instant message, and the text link is associated with the jump link.

Example 4. The method according to any one of examples 1-3, further including:
acquiring a selection of the user for a presentation mode of the instant message in the collaborative document; or
determining the presentation mode to be the card view in response to the user not selecting the presentation mode.

Example 5. The method of any one of examples 1-4, further including:
acquiring a permission for a user on editing the collaborative document;
receiving an action of the user on switching the presentation mode; and
presenting the instant message to the user in the collaborative document based on the switched presentation mode.

Example 6. The method of any one of examples 1-5, wherein jumping to the window of the chat where the instant message is located includes:
jumping to the window, and locating the instant message in the window of the chat and highlighting the instant message in the window of the chat in response to determining that the chat wherein the instant message is located is a single chat or a private group chat, and the user is a member of the chat; or
prompting the user that the user cannot jump in response to determining that the chat where the instant message is located is a single chat or a private group chat, and the user is not in the chat where the instant message is located; or
jumping to the window, and locating the instant message in the window of the chat and highlighting the instant message in the window of the chat in response to determining that the chat where the instant message is located is a public group chat.

Example 7. The method of any one of examples 1-6, wherein the source of the instant message includes one of the following:
a group chat message from a group chat;
a single chat message from a single chat; or
an instant message that has been presented in a collaborative document.

Example 8. The method according to any one of examples 1-7, where the presentation mode is the card view, and the method further includes:
determining whether the user is in the chat; and
presenting a name of the chat to the user in response to determining that the user is in the chat; or
presenting the source of the instant message to the user without presenting the name of the chat in response to determining that the user is not in the chat.

Example 9. The method of any one of examples 1-8, wherein the presentation mode is the link view, and the method further includes:
determining whether the user is in the chat; and
presenting the text link to the user in response to determining that the user is in the chat; or
presenting the jump link associated with the instant message to the user without presenting the text link in response to determining that the user is not in the chat.

Example 10. The method of any one of examples 1-9, wherein presenting the instant message to the user in the collaborative document according to the presentation mode includes:
acquiring a pixel height of the instant message;
determining a threshold height of a predetermined presentation region in the collaborative document; and
presenting a part of the instant message matching the threshold height in the collaborative document in response to the pixel height being greater than the threshold height.

Example 11. The method of any one of examples 1-10, wherein presenting the part of the instant message matching the threshold height in the collaborative document includes:
determining a first part of the instant message, where a pixel height of the first part is less than or equal to the threshold height, and the first part is presented in the predetermined presentation region by default;
generating a side scroll bar, where the side scroll bar is used for controlling a presentable part of the instant message;
presenting the first part in the predetermined presentation region in a screen; and
presenting a second part of the instant message in response to receiving an action of scrolling the side scroll bar, where the second part is associated with a scrolling position of the side scroll bar.

Example 12. The method of any one of examples 1-11, further including:
determining whether the user has logged in to an account of the collaborative document; and
prompting the user to log in to the account of the collaborative document in response to the user not logged in.

Example 13. The method of any one of examples 1-12, where the previewable card includes at least one of the following:
an avatar of a publisher of the instant message;
a name of a publisher of the instant message;
a publishing time or date of the instant message;
content of the instant message; or
a comment on the instant message.

Example 14. The method of any one of examples 1-13, where in response to the link of the instant message being acquired from the window of the chat, presenting the instant message to the user in the collaborative document according to the presentation mode includes:
creating a message content block, and parsing the link of the instant message, and acquiring message content; and
determining a link type of the link of the instant message, and converting the message content block into a message preview content block corresponding to the link type according to the link type and the message content.

Example 15. The method of any one of examples 1-14, wherein in response the link of the instant message being acquired from the collaborative document, presenting the instant message to the user in the collaborative document according to the presentation mode includes:
parsing the link into a text content block in response to a copy operation for the instant message in the collaborative document, wherein the text content block includes the link of the instant message;
reading, through a message service, message data in a cache in response to pasting the instant message in a current collaborative document, and in response to the user having a permission on reading the instant message, generating and displaying a message content block according to the text content block; and in response to the user not having permission on reading the instant message, displaying the link of the instant message; or
acquiring, through the message service, the message data from an instant messaging client in response to pasting the instant message in another collaborative document, and in response to the user having the permission on reading the instant message, generating and displaying the message content block according to the text content block; and in response to the user not having the permission on reading the instant message, displaying the link of the instant message.

Example 16. The method of any one of examples 1-15, further including:

displaying a reply message in the collaborative document in response to a reply operation for the instant message presented in the collaborative document.

Example 17. The method of any one of examples 1-16, where displaying the reply message in the collaborative document in response to the reply operation for the instant message presented in the collaborative document includes:
generating, in response to an emoticon reply to a target message, emoticon information in a message entry of the target message, the emoticon information being placed at bottom of the message entry;
displaying, in response to a reference reply to the target message, a message including content of the target message and content of a reply in the collaborative document; or
displaying, in response to a reply to the instant message, a new message including content of the reply in the collaborative document.

Example 18. The method of any one of examples 1-17, further including:
synchronously displaying a reply message in a chat corresponding to the instant message.

Example 19. The method of any one of examples 1-18, wherein in response to the instant message being a topic message, a schedule message, or a workflow message, further including any of the following:
displaying a reply message in the instant message presented in the collaborative document in response to a new reply message being generated for the topic message in the chat;
displaying a status change in the instant message presented in the collaborative document in response to a new status change being generated for a schedule message in the chat; or
displaying a node message in the workflow message presented in the collaborative document in response to a new node message being generated for a workflow message in the chat.

Example 20. The method of any one of examples 1-19, wherein the instant message presented in the collaborative document includes user identification information of a message sender;
displaying a contact card of the user in response to a trigger operation on the user identification information; and displaying an instant messaging chat window with the user in response to a trigger operation on a preset control in the contact card.

Example 21. The method of any one of examples 1-20, where in response to the instant message including a link of a target collaborative document;
determining whether a current user has a read permission for the target collaborative document;
in response to the current user having the read permission for the target collaborative document, document preview information corresponding to the link in the instant message; and
in response to the current user not having the read permission for the target collaborative document, displaying the link in the instant message.

Example 22. An apparatus of presenting an instant message, including:
a presentation mode determination module configured to determine a presentation mode of an instant message in a collaborative document, wherein the presentation mode includes a card view or a link view;
an instant message presentation module configured to present the instant message to a user in the collaborative document according to the presentation mode; and
a chat window jump module configured to jump to a window of a chat where the instant message is located in response to receiving a trigger on a jump link of the instant message.

Example 23. An electronic device, including:
a processor; and
a memory coupled to the processor, the memory having instructions stored thereon, the instructions, when executed by the processor, causing the electronic device to perform actions, the actions including:
determining a presentation mode of an instant message in a collaborative document, where the presentation mode includes a card view or a link view;
presenting the instant message to a user in the collaborative document according to the presentation mode; and
jumping to a window of a chat where the instant message is located in response to receiving a trigger on a jump link of the instant message.

Example 24. A computer-readable storage medium having one or more computer instructions stored thereon, where the one or more computer instructions are executed by a processor to implement the method according to any one of examples 1 to 21.

Example 25. A computer program product tangibly stored on a computer-readable medium and including computer-executable instructions, the computer-executable instructions, when executed by a device, causing the device to implement the method according to any one of examples 1 to 21.

Although the present disclosure has been described in language specific to structural features and/or logical actions of methods, it should be understood that the subject matter defined in the appended claims is not necessarily limited to the specific features or actions described above. Rather, the specific features and actions described above are merely example forms of implementing the claims.

1. A method of presenting an instant message, comprising:
determining a presentation mode of an instant message in a collaborative document, wherein the presentation mode comprises a card view or a link view;
presenting the instant message to a user in the collaborative document according to the presentation mode; and
jumping to a window of a chat where the instant message is located in response to receiving a trigger on a jump link of the instant message.

2. The method of claim 1, wherein the card view comprises a previewable card rendered based on content of the instant message, and the previewable card further comprises a text link generated based on a source of the instant message, and the text link is associated with the jump link.

3. The method of claim 1, wherein the link view comprises a text link generated based on a source of the instant message, and the text link is associated with the jump link.

4. The method of claim 1, further comprising:
acquiring a selection of the user for a presentation mode of the instant message in the collaborative document; or
determining the presentation mode to be the card view in response to the user not selecting the presentation mode.

5. The method of claim 4, further comprising:
acquiring a permission for a user on editing the collaborative document;
receiving an action of the user on switching the presentation mode; and
presenting the instant message to the user in the collaborative document based on the switched presentation mode.

6. The method of claim 1, wherein jumping to the window of the chat where the instant message is located comprises at least one of the following:
jumping to the window, and locating the instant message in the window of the chat and highlighting the instant message in response to determining that the chat where the instant message is located is a single chat or a private group chat, and the user is a member of the chat;
prompting the user that the user cannot jump in response to determining that the chat where the instant message is located is a single chat or a private group chat, and the user is not in the chat where the instant message is located; or
jumping to the window, and locating the instant message in the window of the chat and highlighting the instant message in response to determining that the chat where the instant message is located is a public group chat.

7. The method of claim 2, wherein the source of the instant message comprises one of the following:
a group chat message from a group chat;
a single chat message from a single chat; or
an instant message that has been presented in a collaborative document.

8. The method of claim 7, wherein the presentation mode is the card view, and the method further comprises:
determining whether the user is in the chat; and
presenting a name of the chat to the user in response to determining that the user is in the chat; or
presenting the source of the instant message to the user without presenting the name of the chat in response to determining that the user is not in the chat,
and wherein the presentation mode is the link view, and the method further comprises:
determining whether the user is in the chat; and
presenting the text link to the user in response to determining that the user is in the chat; or
presenting the jump link associated with the instant message to the user without presenting the text link in response to determining that the user is not in the chat.

9. (canceled)

10. The method according to claim 1, wherein presenting the instant message to the user in the collaborative document according to the presentation mode comprises:
acquiring a pixel height of the instant message;
determining a threshold height of a predetermined presentation region in the collaborative document; and
presenting a part of the instant message matching the threshold height in the collaborative document in response to the pixel height being greater than the threshold height.

11. The method of claim 10, wherein presenting the part of the instant message matching the threshold height in the collaborative document comprises:
determining a first part of the instant message, wherein a pixel height of the first part is less than or equal to the threshold height, and the first part is presented in the predetermined presentation region by default;
generating a side scroll bar, wherein the side scroll bar is used for controlling a presentable part of the instant message;
presenting the first part in the predetermined presentation region in a screen; and
presenting a second part of the instant message in response to receiving an action of scrolling the side scroll bar, wherein the second part is associated with a scrolling position of the side scroll bar.

12. The method of claim 1, further comprising:
determining whether the user has logged in to an account of the collaborative document; and
prompting the user to log in to the account of the collaborative document in response to the user not logged in.

13. The method of claim 1, wherein the previewable card comprises at least one of the following:
an avatar of a publisher of the instant message;
a name of a publisher of the instant message;
a publishing time or date of the instant message;
content of the instant message; or
a comment on the instant message.

14. The method of claim 1, wherein in response to the link of the instant message being acquired from the window of the chat, presenting the instant message to the user in the collaborative document according to the presentation mode comprises:
creating a message content block, and parsing the link of the instant message, and acquiring message content; and
determining a link type of the link of the instant message, and converting the message content block into a message preview content block corresponding to the link type according to the link type and the message content.

15. The method of claim 1, wherein in response to the link of the instant message being acquired from the collaborative document, presenting the instant message to the user in the collaborative document according to the presentation mode comprises at least one of the following:
parsing the link into a text content block in response to a copy operation for the instant message in the collaborative document, wherein the text content block comprises the link of the instant message;
reading, through a message service, message data in a cache in response to pasting the instant message in a current collaborative document, and in response to the user having a permission on reading the instant message, generating and displaying a message content block according to the text content block; and in response to the user not having the permission on reading the instant message, displaying the link of the instant message; or
acquiring, through the message service, the message data from an instant messaging client in response to pasting the instant message in another collaborative document, and in response to the user having the permission on reading the instant message, generating and displaying the message content block according to the text content block; and in response to the user not having the permission on reading the instant message, displaying the link of the instant message.

16. The method of claim 1, further comprising:
displaying a reply message in the collaborative document in response to a reply operation for the instant message presented in the collaborative document.

17. The method of claim 16, wherein displaying the reply message in the collaborative document in response to the reply operation for the instant message presented in the collaborative document comprises at least one of the following:
generating, in response to an emoticon reply to a target message, emoticon information in a message entry of the target message, the emoticon information being placed at bottom of the message entry;
displaying, in response to a reference reply to the target message, a message comprising content of the target message and content of a reply in the collaborative document; or
displaying, in response to a reply to the instant message, a new message comprising content of the reply in the collaborative document,
and the method further comprises:
synchronously displaying a reply message in a chat corresponding to the instant message.

18. (canceled)

19. The method of claim 1, wherein in response to the instant message being a topic message, a schedule message, or a workflow message, further comprising any of the following:
displaying a reply message in the instant message presented in the collaborative document in response to a new reply message being generated for the topic message in the chat;
displaying a status change in the instant message presented in the collaborative document in response to a new status change being generated for a schedule message in the chat; or
displaying a node message in the workflow message presented in the collaborative document in response to a new node message being generated for a workflow message in the chat.

20. The method of claim 1, wherein the instant message presented in the collaborative document comprises user identification information of a message sender;
and the method further comprises:
displaying a contact card of the user in response to a trigger operation on the user identification information; and displaying an instant messaging chat window with the user in response to a trigger operation on a preset control in the contact card,
and the method further comprises:
in response to the instant message comprising a link of a target collaborative document, determining whether a current user has a read permission for the target collaborative document:
in response to the current user having the read permission for the target collaborative document. displaying document preview information corresponding to the link in the instant message; and
in response to the current user not having the read permission for the target collaborative document. displaying the link in the instant message.

21. (canceled)

22. (canceled)

23. An electronic device, comprising:
a processor; and
a memory coupled to the processor, the memory having instructions stored thereon, the instructions, when executed by the processor, causing the electronic device to-perform.:
determine a presentation mode of an instant message in a collaborative document, wherein the presentation mode comprises a card view or a link view;
present the instant message to a user in the collaborative document according to the presentation mode; and
jump to a window of a chat where the instant message is located in response to receiving a trigger on a jump link of the instant message.

24. A computer-readable storage medium having computer-executable instructions stored thereon, wherein the computer-executable instructions, when executed by a processor, causing the processor to:
determine a presentation mode of an instant message in a collaborative document, wherein the presentation mode comprises a card view or a link view:
present the instant message to a user in the collaborative document according to the presentation mode; and
jump to a window of a chat where the instant message is located in response to receiving a trigger on a jump link of the instant message.
